(19) United States
(12) Patent Application Publication
(10) Pub. No.: US 2025/0203546 A1
(43) Pub. Date: Jun. 19, 2025

(54) TIMING DETECTION IN A DEMODULATOR

(71) Applicant: Silicon Laboratories Inc., Austin, TX (US)

(72) Inventors: Xushuai Qu, Austin, TX (US); Guner Arslan, Austin, TX (US); Robert M. Gorday, Gainsville, FL (US); Yan Zhou, Spicewood, TX (US); Yi Shen Yeh, Austin, TX (US)

(21) Appl. No.: 18/545,300

(22) Filed: Dec. 19, 2023

(51) Int. Cl. H04W 56/00

(52) U.S. Cl. CPC H04W 56/0035

(57) ABSTRACT

A demodulator in a receiver performs timing detection timing by generating first and second correlation results based on correlation of a first and second training sequence received by the receiver against a known first and a known second training sequence. Third correlation results are generated based on correlation of the first training sequence combined with the second training sequence with the known first training sequence and the known second training sequence. The demodulator detects respective peaks in the first correlations results and the second correlations results and a plurality of peaks in the third correlation results. A true peak in the plurality of peaks corresponding to an end of the second training sequence is identified based on a first peak in the first correlation results and a second peak in the second correlation results.

### BACKGROUND

### Field of the Invention

This disclosure relates to communications systems in general, and more particularly to a demodulator in a radio frequency (RF) communications system providing timing estimation.

### Description of the Related Art

In a typical wireless communications system, coherent reception requires that the frequency and phase of the local oscillator at the receiving wireless communications device be identical to the frequency and phase of the carrier wave generated at the transmitting wireless communications device. That is, the difference in phase (i.e., phase offset) and difference in frequency (i.e., frequency offset) between the local oscillator of the receiver and the carrier wave generated using a remote oscillator at a transmitter, should be zero. In addition, timing needs to be accurately determined to know, e.g., where a control packet begins and ends. Noise and/or any frequency offset or frequency drift between the local oscillator of the receiving wireless communications device and a frequency of a remote oscillator of a transmitting wireless communications device can introduce error into recovered data or measurements based on the received signal. Accordingly, techniques that accurately determine timing and reduce or eliminate effects of frequency or phase offset at a receiving wireless communications device are desired.

### SUMMARY OF EMBODIMENTS OF THE INVENTION

In at least one embodiment, a method for timing detection includes correlating first received symbols with a first plurality of training symbols to generate first correlation results. The method further includes correlating second received symbols with a second plurality of training symbols to generate second correlation results. The method further includes correlating third received symbols that include the first received symbols and the second received symbols with a third plurality of training symbols that include the first plurality of training symbols and the second plurality of training symbols to generate third correlation results. A plurality of peaks are identified in the third correlation results and the true peak of the plurality of peaks in the third correlation results is determined using the first correlation results and the second correlation results. The true peak corresponds to an end of a training sequence.

In at least one embodiment a receiver includes a memory to store symbols received by the receiver. A first correlator is configured to correlate first symbols supplied from the memory and first training symbols and generate first correlation results. A second correlator is configured to correlate second symbols supplied from the memory and the first training symbols and generate second correlation results. A summing circuit generates third correlation results by summing the first correlation results and the second correlation results. Detection logic identifies a plurality of peaks in the third correlation results and determines which of the plurality of peaks in the third correlation results is a true peak using the first correlation results and the second correlation results. The true peak indicates an end of a training sequence.

Another embodiment provides a method for detecting timing in a receiver that includes generating first correlation results based at least in part on correlation of a first training sequence received by the receiver with a known first training sequence. Second correlation results are generated based at least in part on correlation of a second training sequence received by the receiver against a known second training sequence. Third correlation results are generated based at least in part on the first training sequence combined with the second training sequence being correlated with the known first training sequence and the known second training sequence. The true peak of a plurality of peaks in the third correlation results is identified based on a first peak in the first correlation results and a second peak in the second correlation results, the true peak indicative of an end of a transmission sequence.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a functional block diagram of an exemplary wireless communications system.

FIG. 2 illustrates a functional block diagram of the exemplary wireless communications transmitter of FIG. 1.

FIG. 3 illustrates a functional block diagram of the exemplary wireless communications receiver of FIG. 1.

FIG. 4 illustrates a functional block diagram of a protocol stack executing on the exemplary wireless communications device of FIG. 1.

FIG. 5 illustrates a functional block diagram of a demodulator including a fine processing block for generating fine timing, frequency and phase offset estimates, and channel estimates.

FIG. 6 illustrates an exemplary transmission pattern showing the various packets being transmitted.

FIG. 7 illustrates an embodiment in which prefix symbols and postfix symbols are added to the long training sequences.

FIG. 8 illustrates the magnitude of the cross correlations resulting from correlations of the long training sequences, both separately and together.

FIG. 9 illustrates the symbols being correlated when correlation peaks occur for the long training sequences.

FIG. 10 illustrates the symbols being correlated when correlation peaks occur for correlations of combined long training sequences.

FIG. 11 illustrates an embodiment of detection and estimation logic for timing detection, frequency offset estimation, and phase offset estimation.

FIG. 12 illustrates an embodiment of a true peak detection operation by way of pseudocode.

FIG. 13 illustrates that any of the three peaks may be the peak with the greatest magnitude.

FIG. 14 illustrates use of the peak index for frequency offset recovery.

FIG. 15 illustrates an embodiment for channel estimation using symbols updated for frequency and phase offset.

The use of the same reference symbols in different drawings indicates similar or identical items.

### DETAILED DESCRIPTION

A communication system uses two (or more) correlations for separate training sequences and combines the correlations to provide nominally three correlation peaks for the combined training sequences. Peaks from correlations of the separate training sequences and the combined correlations are used to facilitate the determination of packet timing.

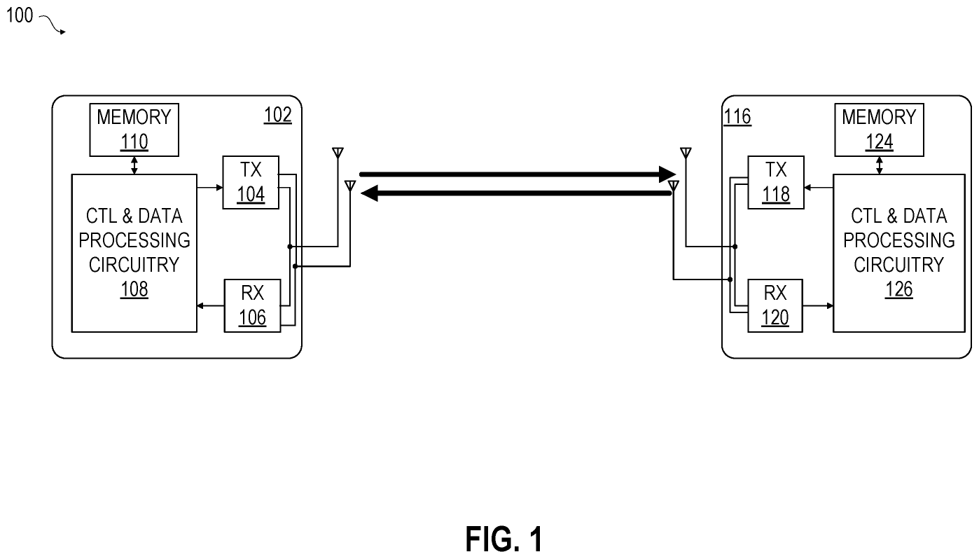

Referring to FIG. 1, an embodiment of a wireless communications system 100 includes wireless communications device 102 and wireless communications device 116, which are devices compliant with the Bluetooth® Low Energy (BLE) communications protocol(s) and/or other communications protocols designed for low power and low latency and/or high data throughput applications. In embodiments, the communication devices are compliant with one or more additional wireless protocols instead of, or in addition to BLE wireless protocols. Wireless communications device 102 includes transmitter 104, receiver 106, control and data processing circuitry 108, and memory 110. Wireless communications device 116 includes transmitter 118, receiver 120, control and data processing circuitry 126, and memory 124. Although wireless communications device 102 and wireless communications device 116 are illustrated as each including only one transmitter, one receiver, and two antennas, in other embodiments of wireless communications system 100, wireless communications device 102 and/or wireless communications device 116 include multiple transmitters, multiple receivers, additional antennas, or a single antenna with internal circuitry selection or radio frequency switches. Wireless communications system 100 communicates information using a predetermined wireless communications protocol, e.g., using a BLE communications protocol. However, in other embodiments, wireless communications system 100 can transmit and receive data compliant with other wireless communications protocols.

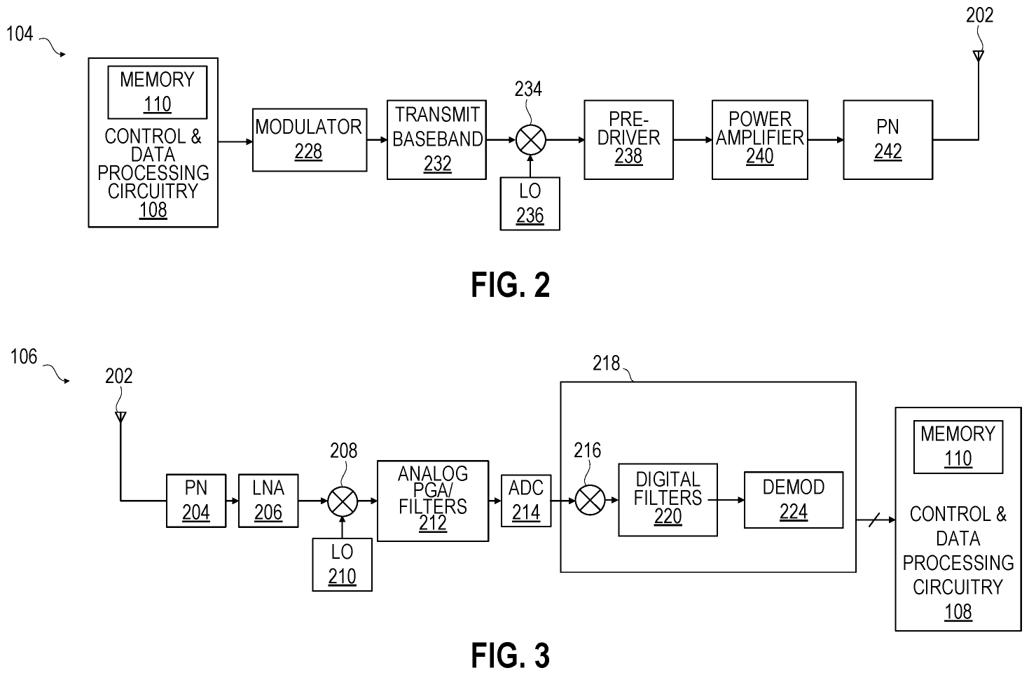

FIG. 2 illustrates an exemplary embodiment of transmitter 104 that may be included in a physical radio of wireless communications device 102 or wireless communications device 116 of FIG. 1. Control and data processing circuitry 108 of FIG. 2 may perform a variety of functions (e.g., logic, arithmetic, etc.). For example, data processing circuitry 108 executes a program, routine, or algorithm (whether in software, firmware, hardware, or a combination thereof) that performs desired control or data processing tasks consistent with a physical layer of a communications protocol and provides data to modulator 228. Modulator 228 applies a predetermined modulation scheme (e.g., phase-shift keying or quadrature amplitude modulation) to data for transmission and provides modulated data to transmit baseband circuit 232, which in an embodiment includes a digital-to-analog converter and analog programmable gain filters. Transmit baseband circuit 232 provides the baseband (or intermediate frequency (IF)) signal to frequency mixer 234, which performs frequency translation or shifting of the baseband signal using a reference or local oscillator (LO) signal provided by local oscillator 236. In at least one operational mode of transmitter 104, frequency mixer 234 translates the baseband signal centered at DC to a 2.4 GHz frequency band. Pre-driver 238 amplifies the signal generated by frequency mixer 234 to a level sufficient for power amplifier 240. Power amplifier 240 further amplifies the signal to provide a higher power signal sufficient to drive passive network 242 and antenna 202. Passive network 242 provides impedance matching, filtering, and electrostatic discharge protection.

FIG. 3 illustrates an exemplary embodiment of receiver 106 that may be included in a radio of the wireless communications devices described above. Antenna 202 provides a radio frequency (RF) signal to passive network 204, which provides impedance matching, filtering, and electrostatic discharge protection. Passive network 204 is coupled to low-noise amplifier (LNA) 206, which amplifies the RF signal without substantial degradation to the signal-to-noise ratio and provides the amplified RF signal to frequency mixer 208. Frequency mixer 208 performs frequency translation or shifting of the RF signal using a reference or local oscillator signal provided by local oscillator (LO) 210. For example, in at least one operational mode of receiver 106, frequency mixer 208 translates the RF signal from a 2.4 GHz frequency band to baseband frequencies centered at DC (i.e., zero-intermediate frequency (ZIF) in a ZIF mode of operation). In another operational mode, receiver 106 is configured as a low-intermediate frequency (LIF) receiver (i.e., in a LIF mode of operation) and frequency mixer 208 translates the RF signal to a low-intermediate frequency (e.g., 100-200 kHz) to reduce or eliminate DC offset and 1/f noise problems of ZIF receivers.

Frequency mixer 208 provides the translated output signal as a set of two signals, an in-phase (I) signal and a quadrature (Q) signal. The I and Q signals are analog time-domain signals. In at least one embodiment of receiver 106, the analog programmable gain amplifier (PGA) and filters 212 provide amplified and filtered versions of the I and Q signals to analog-to-digital converter (ADC) 214, which converts those versions of the I and Q signals to digital I and Q signals (i.e., I and Q samples). Exemplary embodiments of ADC 214 use a variety of signal conversion techniques (e.g., delta-sigma (also referred to as sigma-delta) analog-to-digital conversion). ADC 214 provides the digital I and Q signals to signal processing circuitry 218. In general, signal processing circuitry 218 performs digital signal processing (e.g., frequency translation (e.g., using digital mixer 216), filtering (e.g., using digital filters 220), demodulation, or signal correction) of the digital I and Q signals. In at least one embodiment, signal processing circuitry 218 includes demodulator 224, which recovers or extracts information from digital I and Q signals (e.g., data signals, that were modulated using phase-shift keying or quadrature amplitude modulation by modulator 228 of transmitter 104 of FIG. 2 and provided to antenna 202 as RF signals).

Referring again to FIG. 3, control and data processing circuitry 108 may perform a variety of functions (e.g., logic, arithmetic, etc.). For example, control and data processing circuitry 108 may use the demodulated data in a program, routine, or algorithm (whether in software, firmware, hardware, or a combination thereof) to perform desired control or data processing tasks. In at least one embodiment, control and data processing circuitry 108, which includes memory 110, controls other circuitry, sub-system, or systems (not shown). In an embodiment, control and data processing circuitry 108 implements a data link layer that includes a state machine, defines state transitions, defines packet formats, performs scheduling, performs radio control, and provides link-layer decryption consistent with at least one wireless communications protocol. Transmitter 104 of FIG. 2 and receiver 106 of FIG. 3 are illustrative only and may vary with the communications protocol implemented by wireless communications system 100 of FIG. 1.

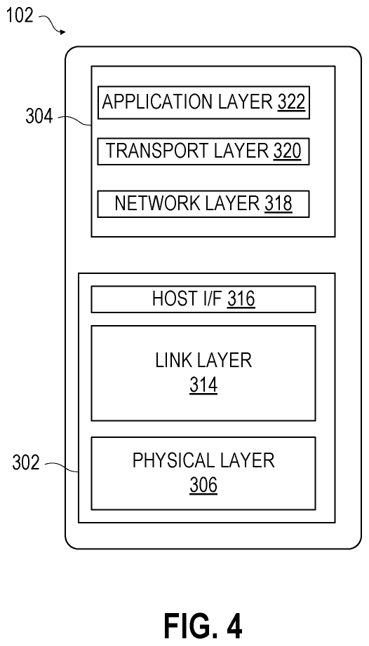

Referring to FIGS. 1 and 4, in an embodiment, wireless communications device 102 includes separate integrated circuits for implementing functions of control and data processing circuitry 108, e.g., controller 302 and host 304. In some embodiments, wireless communications device 102 incorporates functionality of controller 302 and host 304 in a single integrated circuit device. Controller 302 and host 304 execute instructions to implement portions of a wireless communications network protocol stack. For example, controller 302 implements physical layer 306, which includes software that interacts with the RF transceiver (e.g., including the transmitter and receiver described above). Link layer 314 interfaces directly to physical layer 306 to handle transmission and reception of associated signals. In at least one embodiment, link layer 314 of controller 302 communicates with host 304 via host interface 316. Host 304 implements upper layers of the communications protocol stack (e.g., network layer 318, transport layer 320, and application layer 322). In other embodiments, the layers of the software protocol stack have different distributions between controller 302 and host 304 or are completely implemented using controller 302.

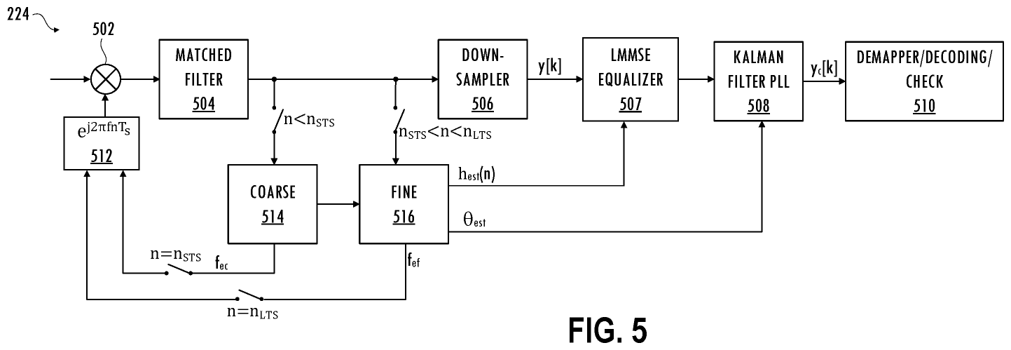

Referring to FIGS. 3 and 5, in at least one embodiment, demodulator 224 receives a digital intermediate frequency signal and digital mixer 502 frequency shifts the signal to baseband (e.g., ZIF) using a reference signal. Under ideal conditions, the baseband signal provided by mixer 502 is perfectly centered around DC. However, mismatch between the remote oscillator on the transmitting wireless communications device and the local oscillator of the receiving wireless communications device causes a frequency or phase offset in the baseband signal. Matched filter 504 increases the signal-to-noise ratio of the received signal but introduces a delay. During a first phase of receiver processing (e.g., during a short training sequence (STS) of a preamble sequence, i.e., n<n_{STS}), coarse timing detection and frequency estimation 514 generates a coarse frequency correction f_{ec} to reduce the frequency offset. During a second phase of receiver processing (e.g., during a long training sequence (LTS) of the preamble sequence, i.e., n_{STS}<n′≤n_{LTS}), fine timing detection and frequency and phase estimation 516 generates fine frequency error correction f_{ef} and initial phase estimation θₑₛₜ to further reduce the frequency or phase offset. The fine timing detection and frequency and phase estimation 516 also generates and supplies a channel estimate (hₑₛₜ(n)) to the linear minimum mean squared error (LMMSE) equalizer 507. Mixer 502 digitally mixes the received signal with a reference signal (e.g., a tone having a programmable frequency) generated by signal generator 512. Prior to detecting the short training sequence (i.e., n<n_{STS}), signal generator 512 is programmed to generate an intermediate frequency tone having frequency f_{if}, which is used to down convert the received signal to baseband or DC using multiplier 502. After detecting the short training sequence, but before detecting the long training sequence (i.e., n_{STS}<n≤n_{LTS}), signal generator 512 is programmed to a coarsely corrected value having frequency f_{if}+f_{ec} to further down-convert the received signal and compensate for frequency offset. After detecting the long training sequence (i.e., n>n_{LTS}), signal generator 512 is programmed to a finely corrected value having frequency f_{if}+f_{ec}+fₑₛ and thus, mixer 502 applies error correction to the received signal. Downsampler 506 generates received signal y[k], which is a version of the received signal that is downsampled from a sample space to a symbol space, and supplies y[k] to the equalizer 507. In other embodiments the fine frequency correction f_{ef} is supplied to a digital mixer (not shown in FIG. 5) located between the down sampler 506 and the equalizer 507 rather than to the signal generator 512 to adjust the frequency of y[k] by the fine frequency correction f_{ef}. Kalman filter based phase-locked loop 508 applies initial phase estimation Best to the received signal and corrects any residual phase error in corrected received signal y_{c}[n], which is a phase-corrected version of received signal y[n]. Demapper/decoding/check circuit 510 recovers transmitted data from corrected received signal y_{c}[n] using demapping, decoding, and error correction techniques.

The focus of this application is on fine timing detection and frequency and phase estimation block 516 that provides timing information identifying, e.g., when the control field starts, generates a fine frequency error correction f_{ef} and an initial phase estimate θₑₛₜ. Block 516 further provides the channel estimate for the channel between the transmitter and receiver.

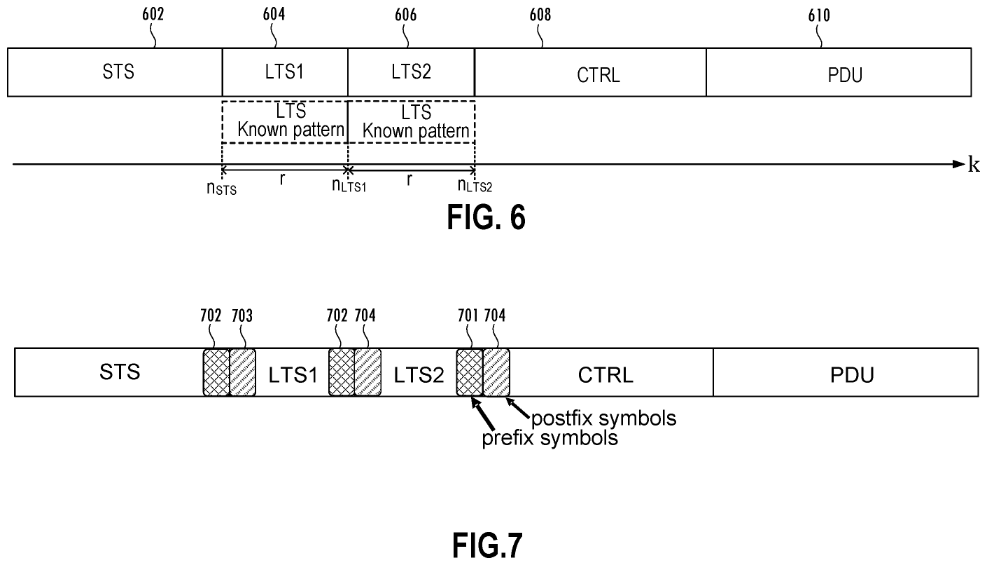

FIG. 6 illustrates an exemplary transmission pattern according to an embodiment. The transmission includes a short training sequence (STS) 602. The number of symbols in the short training sequence varies in different embodiments. For example, in an embodiment each STS includes 4 symbols and there can be multiple short training sequences. A long training sequence (LTS) follows the STS. As shown in FIG. 6 two long training sequences LTS1 604 and LTS2 606 follow the STS. In an embodiment, each LTS has “r” symbols, where r is an integer having a value of, e.g., between 15 and 20. Other embodiments have a number of symbols in the LTS outside that range. The long training sequence can be considered a long training sequence having two equal and identical parts. In other embodiments, the two parts may not have an equal number of symbols and may use different training sequences. The value the symbols used in the training sequence can vary in different embodiments. A control packet (CTRL) 608 follows the two long training sequences. The control packet includes information about the payload, e.g., address, packet length, error checking codes such as cyclic redundancy checks (CRC), and other necessary information for the data to reliably reach its destination. The payload PDU (protocol data unit) 610 follows the control packet(s) and contains the payload data being transmitted. The size and structure of the PDU payload can vary depending on the protocol being used. FIG. 7 shows an embodiment in which prefix symbols 702 and postfix symbols 704 are added to the transmission pattern. Thus, for the prefix 702, LTS packet portion 701 at the end of the LTS is copied to the beginning of the LTS. For the postfix 704, a copy of the beginning portion 703 of the LTS packet is appended to the end of the LTS packet. The number of symbols in the prefix and postfix vary according to the particular protocol being implemented, but can be in the range of, e.g., 3-7 symbols (or other appropriate number for the protocol).

Assume the communications device 102 (see FIG. 1) transmits the signal s[k] to the communication device 116. The transmitted signal is defined as:

$$s [ k ] = \{ \begin{matrix}{s}_{STS} [ k ] for k \leq a , where a is the number of symbols in the STS ; \\ {s}_{LTS} [ k ] for a < k \leq b , wherein b is the last symbol in the LTS ; \\ {s}_{CTRL} [ k ] for b < k \leq c , where c is the last symbol in the CTRL ; \\ {s}_{PDU} [ k ] for c < k\end{matrix}$$

where k is the symbol index. The received symbol y[k]=s[k]e^{j2πf}^{ₑ}^{kT}^{ₛ}^{+θ}, where fₑ is the frequency error (or offset) between the transmitting device and the receiving device, θ is the phase offset, and Tₛ is the period of the transmitted signal.

The fine processing block performs cross correlation to determine the fine timing and frequency/phase offset estimation. The cross-correlation (XC) is defined as E{y[k] s*_{LTS}[k]}=Σₙ₌₁^{n=r}y[k−n] LTS*[n]

When the first LTS symbol is received (k=n_{LTS1} as shown in FIG. 6):

$$\begin{matrix}α = {\sum }_{n = 1}^{n = r} ( ( LTS [ n ] {e}^{j 2 π {f}_{e} ( k - n ) {T}_{s} + θ} ) {LTS}^{*} [ n ] ) \\ = {\sum }_{n = 1}^{n = r} ( {e}^{j 2 π {f}_{e} ( {n}_{{LTS}_{1} - n ) {T}_{s} + θ}} ) \\ = {e}^{j 2 π {f}_{e} {n}_{{LTS}_{1}} {T}_{s} + θ} {\sum }_{n = 1}^{n = r} ( {e}^{- j 2 π {f}_{e} n {T}_{s}} ) \\ = {e}^{j 2 π {f}_{e} {n}_{{LTS}_{1}} {T}_{s} + θ - 2 π {f}_{e} r / 2 {T}_{s}}\end{matrix}$$

When the last symbol in the second LTS is received (k=n_{LTS2} as shown in FIG. 6) β=Σₙ₌₁^{n=r}((LTS[n]e^{j2πf}^{ₑ}^{(k-n)T}^{ₛ}^{+θ})LTS*[n])=e^{j2πf}^{ₑ}^{nLTS}^{₂}^{T}^{ₛ}^{+θ-2πf}^{ₑ}^{r/2T}^{ₛ}. Multiplying B by the conjugate of a: βα*=e^{j2πf}^{ₑ}⁽ⁿ^{^{iTS2}}⁻ⁿ^{_{LTS1}}^{)T}^{ₛ}=e^{j2πf}^{ₑ}^{rT}^{ₛ}.

The frequency estimation is then given by:

$${f}_{ef} = \frac{arg \{ β {a}^{*} \}}{2 π {rT}_{s}} .$$

The initial phase estimate is given by θₑₛₜ=arg {βα*(β+α)}
Timing detection is determined using the correlation magnitude being greater than a threshold or |E{y[k]s*_{LTS}[k]}|>γ.

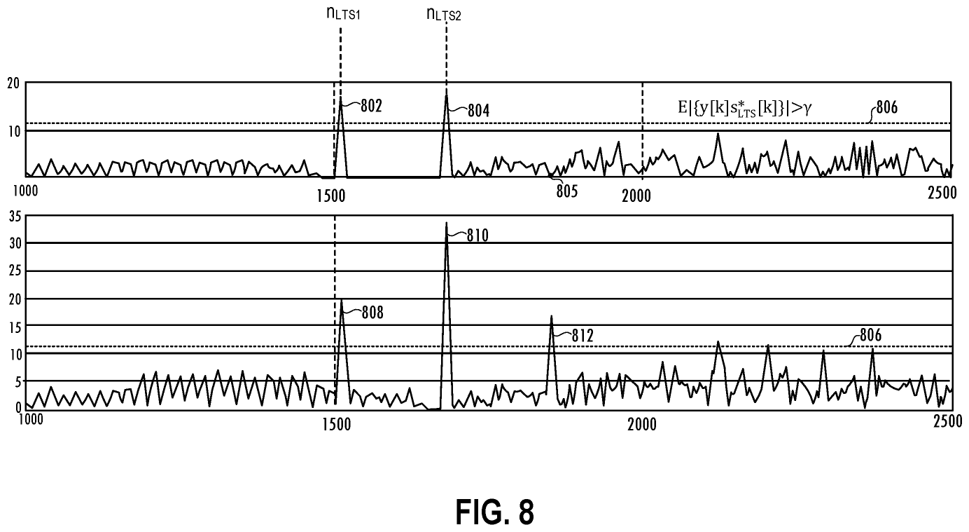

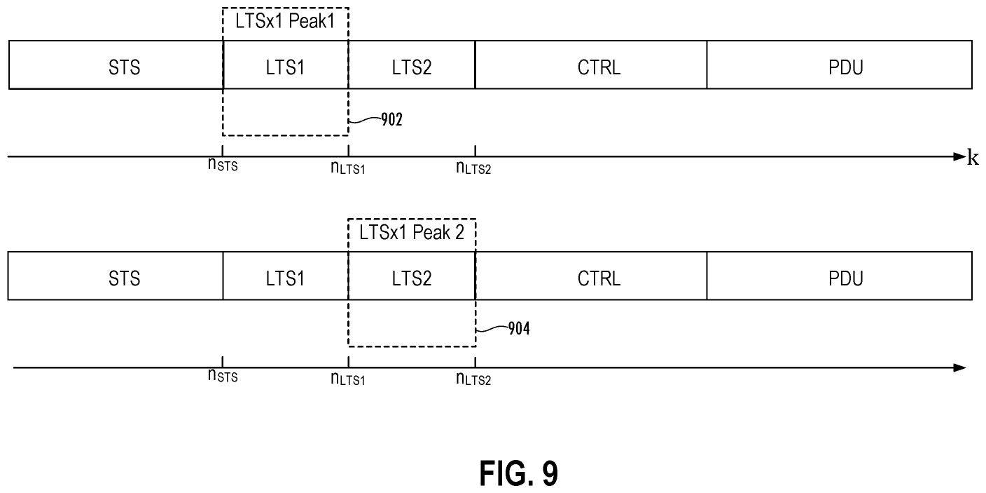

FIG. 8 illustrates the magnitude (absolute value) of the cross correlation resulting from the separate correlation of both LTS1 and LTS, i.e. the correlation of r symbols in each LTS), and the combination of LTS1 and LTS2 (the correlation of 2r symbols for the combination of LTS1 and LTS2). The first peak 802 occurs when k=n_{LTS1} (see FIG. 6) at the end of first LTS (LTS1). The number of symbols being correlated is the length of LTS1. The second peak 804 occurs when k=n_{LTS2} (see FIG. 6) at the end of second LTS (LTS2). The number of symbols being correlated is the length of LTS2. The first and second peaks are determined by XC_{LTSx1}=|Σₙ₌₁^{n=r}(y[k−n])LTSx1*[n])|. Thus, the known LTS symbols are correlated against the received LTS symbols and the peaks occur when the received symbols are aligned with the expected symbols. Note that the peaks are above the threshold 806. FIG. 9 illustrates at 902 the LTS1 symbols being correlated resulting in peak 1 and at 904 the LTS2 symbols being correlated resulting in peak 2.

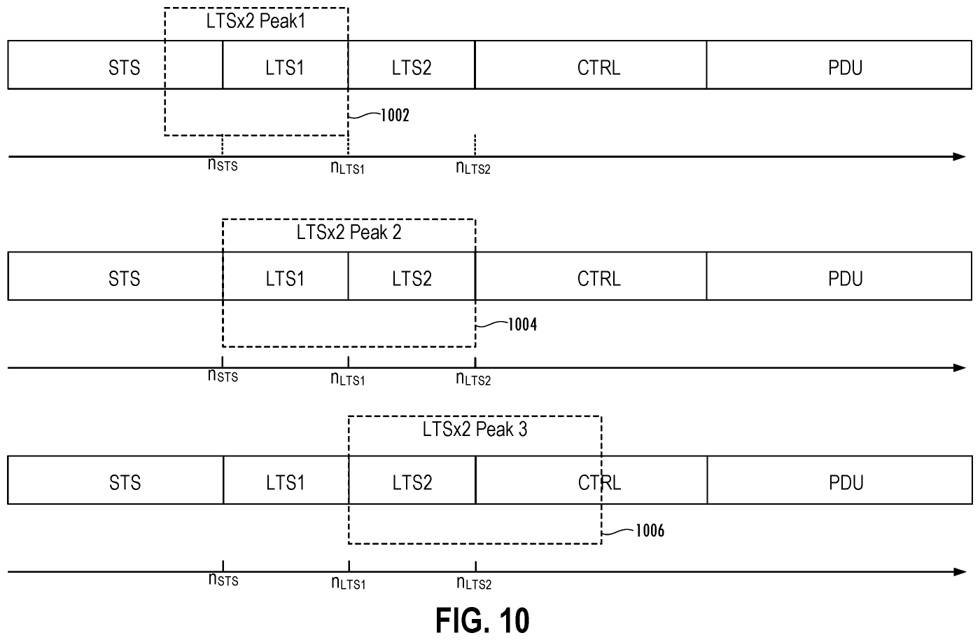

FIG. 8 also shows peaks that occur based on correlation of LTS1 and LTS2 combined. In particular, the first peak 808 (peak 1) of the three peaks occurs when 2r symbols (or the number of symbols in LTS1 and LTS2 combined) are correlated but only the first LTS has been received at k=n_{LTS1}. Thus, as shown in FIG. 10 at 1002, the 2r symbols being correlated include symbols from the STS along with LTS1 symbols. The second peak 810 (peak 2) of the three peaks occurs at k=n_{LTS2} when all the LTS1 and LTS2 received symbols align with the expected symbols. Thus, all the received symbols being correlated are LTS1 and LTS2 as shown at 1004 in FIG. 10. Under ideal conditions peak 2 is the largest peak. For the third peak 812 (peak 3) the received symbols being correlated include LTS2 and control symbols as shown at 1006 in FIG. 10 and thus the correlation magnitude is typically lower than peak 2. The first, second, and third peaks are determined by: XC_{LTSx2}=|Σₙ₌₁^{n=2r}(y[k−n])LTSx2*[n])|.

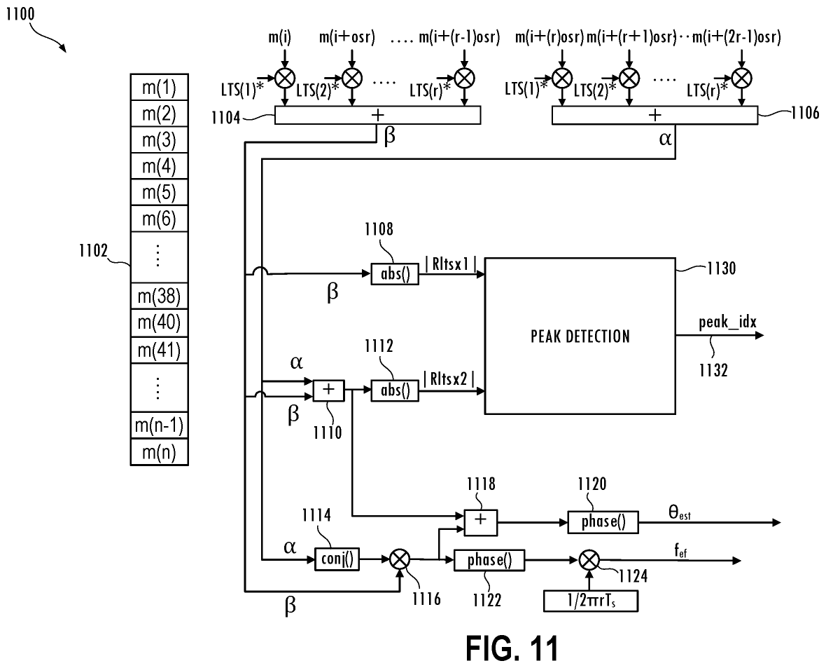

FIG. 11 illustrates an embodiment of detection and estimation logic 1100 for timing detection, frequency offset estimation, and phase offset estimation. The detection and estimation logic 1100 includes memory 1102, which stores received symbols. Thus, the detection and estimation logic operates from memory rather than in real time. The memory supplies stored symbols to correlation logic 1104 and 1106. The correlation logic correlates the known LTS symbols (LTS(1), LTS(2), . . . , LTS(r)), against the received symbols. Note that the memory locations supplied to the correlation logic is incremented by the oversampling ratio (OSR) to make sure the symbols being correlated correspond to the same sample time for each symbol. The correlation logic 1104 generates β, where β=Σₙ₌₁^{n=r}LTS[n]e^{j2πf}^{ₑ}^{(k-n)T}^{ₛ}^{+θ})LTS*[n]), which is described above. The correlation logic 1106 generates a (described above), where α=Σₙ₌₁^{n=r}((LTS[n]e^{j2πf}^{ₑ}^{(k-n)T}^{ₛ}^{+θ})LTS*[n]). The detection and estimation logic 1100 takes the absolute value of β at 1108. The detection and estimation logic 1100 sums α and β at 1110 to generate the combined correlation (correlation of LTS1 and LTS2) and takes the absolute value at 1112. The detection and estimation logic 1100 takes the conjugate of a at 1114 and multiplies β by α* in 1116 to generate βα*. The detection and estimation logic 1100 generates the initial phase estimate θₑₛₜ by summing βα* with (α+β) in 1118 and taking the phase of the sum in 1120, as described above. The detection and estimation logic 1100 also generates frequency estimate f_{ef} by taking the phase of βα* in 1122 and dividing the result in 1124 by 2πrTₛ, where Tₛ is the symbol period. The detection and estimation logic 1100 is implemented as memory in combination with programmable logic, such as a microcontroller unit (MCU) or other processor along with software and/or firmware, hardware, or a combination of programmable logic and hardware.

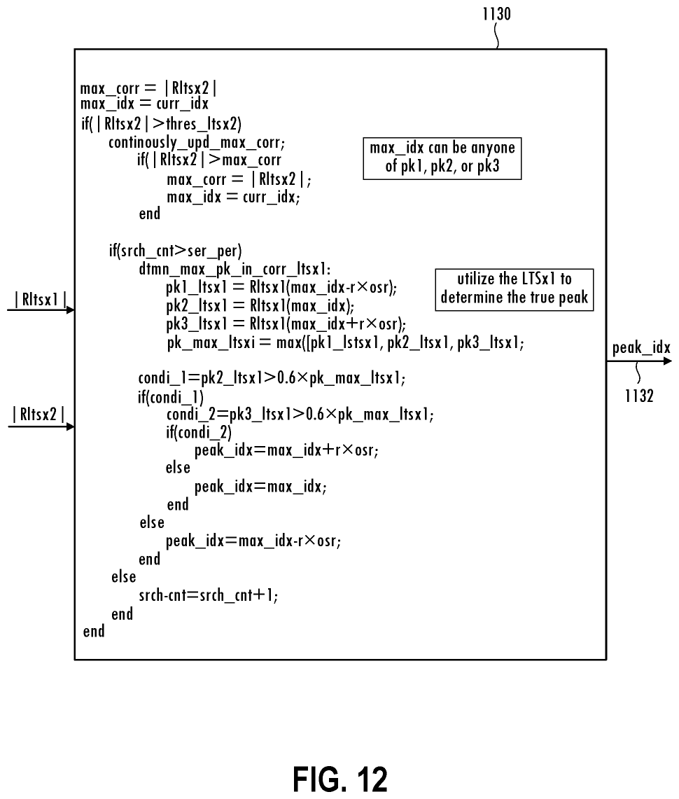

The detection and estimation logic 1100 further includes peak detection logic 1130 to generate the peak index (peak_idx) 1132, which identifies the start of packets such as the control packet 608 (see FIG. 6) as well as identifying which of the OSR samples should be selected. FIG. 12 shows the peak detection logic by way of pseudocode. The peak detection logic receives |B|(|Rltsx1|) and |α+β|(|Rltsx2|) and supplies the peak_idx 1132. Rlsx1 represents the result from correlation of r symbols and Rltsx2 indicates the result from correlation of 2r symbols.

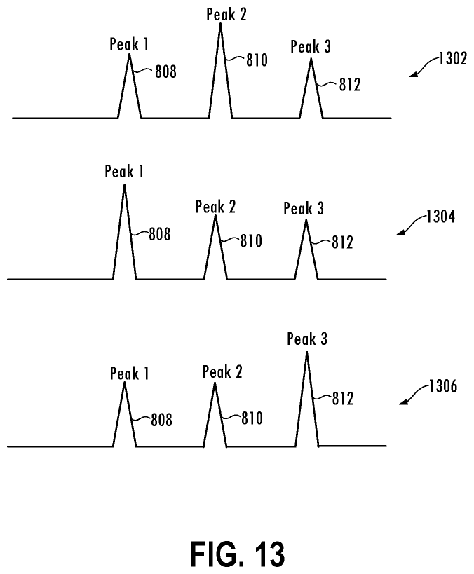

FIG. 13 illustrates the three peaks (peak 1 808, peak 2 810, and peak 3 812) that correspond to the three peaks shown in FIG. 8 and represent magnitude of the correlation of the combination of LTS1 and LTS2. Ideal conditions result in the three peaks shown at 1302. In 1302 the largest cross correlation magnitude peak 810 occurs when the expected LTS1 and LTS2 symbols are correlated against the received symbols at n_{LTS2} as shown in FIGS. 8 and 10. However, frequency offset can affect the peaks and result in peak 1 808 or peak 3 812 being greater in magnitude than peak 2 810. If those peaks are treated as peak 2 because they are highest, the detection logic will falsely identify packet boundaries and receiver will interpret the control packet incorrectly leading to a transmission failure. The peak detection logic 1130 ensures that if those undesired situations occur, the true peak is correctly identified.

Referring back to FIG. 12, the detection logic initializes the variables maximum correlation peak (max_corr) and the memory location (max_idx) of the maximum correlation peak. The detection logic then checks if the magnitude of the LTSx2 correlation peak (Rltsx2) is greater than the threshold and if so, assigns the maximum correlation peak (max_corr) to that value of Rltsx2. The detection logic also assigns the memory index to the current index (curr_idx) for Rltsx2. The threshold is shown, e.g., as 806 in FIG. 8. The peak detection logic then continuously monitors the cross correlations for a period of time sufficient (e.g., past the time to detect peak 3) to detect all three peaks to determine the maximum peak. When the current peak (Rltsx2) exceeds the current maximum, the maximum peak becomes the current peak. In addition to the value of the maximum peak, the index (max_idx) in memory 1102 of the maximum peak is also tracked. The max_idx in ideal conditions corresponds to the location in memory of the last sample of the LTS2. That location corresponds to the correlators 1104 and 1106 correlating the received LTS1 and LTS2 symbols in combination with the expected LTS1 and LTS2 symbols. That location is the index of the true peak and marks the end of LTS and the beginning of the control packet CTRL. But under non-ideal conditions the largest peak can be other than the true maximum peak.

Once the search for the LTSx2 correlations peak is completed, the detection logic checks to see if the maximum peak is the true peak. That is the detection logic checks if peak 1 808 (shown at 1304) was determined to be the maximum peak or if peak 3 812 shown at 1306 was determined to be the maximum peak. The search uses the peaks 802 and 804 (see FIG. 8) determined in the separate LTS1 and LTS2 correlations (Rltsx1) to determine if the maximum peak is the true maximum peak.

Once the search count (srch_cnt) is greater than the search period (srch_per), meaning that the peaks can be accurately determined, the detection logic defines pk1_ltsx1 to be the peak stored at (max_idx-rxosr), where osr is the oversampling rate and r is the number of symbols in LTS1 (and in LTS2). The reference to ltsx1 refers to the correlations of length r provided by correlation logic 1104 and 1106. The detection logic defines peak 2 to be the peak at max_idx, and pk3 to be the peak at (max_idx+rxosr). The osr factor ensures the right sample is being selected. Assuming, e.g., the osr is four, then each symbol would be represented by four samples in memory 1102. If the maximum index is the index of the true peak, pk1 corresponds to the peak 802 (see FIG. 8), pk2 corresponds to the peak 804 and pk3 corresponds to the magnitude of the LTSx1 shown at 805 in FIG. 8, which occurs at the same time as peak 3 812 and is below the threshold. Note that the max_idx also identifies the best sample for the down sampler 506 (see FIG. 5) because the max_idx indicates the sample that yields the largest correlation. Thus, if the osr=4, the best of the four samples for the last symbol is pointed to by the max_idx.

The detection logic 1130 defines several conditions to determine the memory location of the true peak. Condition 1 (condi_1) corresponds to the pk2_ltsx1 being greater an LTS1 threshold (0.6*pk_max_ltsx1), which is a percentage of the maximum LTSx1 peak found. Condition 2 (condi_2) corresponds to pk3_ltsx1 also being greater than an LTS1 threshold (0.6*pk_max_ltsx1). If both condition 1 and condition 2 are true, that means one LTSx1 peak occurs at the max index (corresponding to peak1 802) and a second LTSx1 peak is peak 804 which is (rx OSR) samples in memory away from peak 802. That means that the peak corresponding to the maximum index must be peak 1 808 and the true peak is (rx OSR) samples in memory away from the current max_idx. Therefore, the peak index is incremented by (r×OSR) to accurately identify the true peak. In this case, even though peak 1 808 was higher than peak 2 802 (see 1304 in FIG. 13), the index of the true peak was adjusted to correct the index to the index of 810. Note that “r” assumes each LTS is r symbols long. In other embodiments, where the LTS length differs, the value of r matches the LTS length being used.

If condition 1 is true but not condition 2, then the peak index (peak_idx) equals the maximum index implying that the LTSx2 peak initially found was the true peak. If condition 1 is not true, that implies that the maximum index corresponds to the situation shown at 1306 in FIG. 3, where peak 3 812 is the largest peak but not the true peak. In that case the true peak index needs to be reduced by (r×OSR) to make the index correspond to the true peak 810. Therefore, in that condition, the detection logic subtracts r from the peak index. Once the true peak index has been determined, the peak index is used subsequently for frequency offset recovery and channel estimation.

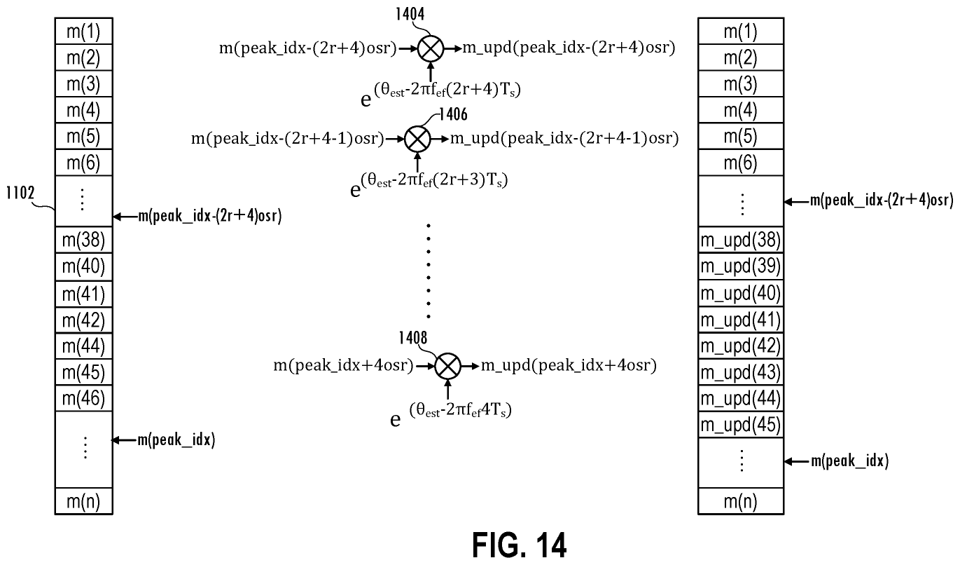

FIG. 14 illustrates how the peak index is used for frequency offset recovery. The peak index (m (peak_idx) points to the location in memory where LTS2 ends. The frequency offset recovery operation updates the received symbols in memory 1102 to correct for frequency and phase offset. The updating operation starts at a memory location based on the memory location (peak_idx). For example, as shown at 1404, the frequency offset recovery (the update operation) for the first symbol selected at the index m (peak_idx−2r+4)osr) is multiplied by e^{(θ}^{ₑₛₜ}^{-2πf}^{_{ef}}^{(2r+4)T}^{ₛ}⁾ and the updated symbol is stored into memory. The “2r” in the memory index assumes r symbols in each of LTS1 and LTS2. Remember that the peak index occurs at the correlation of the 2r symbols of LTS1 and LTS2. The “+4” assumes prefix symbols are also being used for the channel estimation. The updated first symbol may be stored back into memory 1102 at m_upd(peak_idx−2r+4)osr), which is the location the symbol was located before being updated or in other embodiments the updated symbol is stored into a different memory location. As shown at 1406, the second symbol selected at the index m (peak_idx−2r+4−1)osr) is multiplied by e^{(θ}^{ₑₛₜ}^{-2πf}^{ₑₛₜ}^{(2r+3)T}^{_{sym}}⁾ and the updated symbol is stored into memory. The second symbol may be stored back into memory 1102 at m_upd (peak_idx−2r+4−1)osr) or into a different memory location. The frequency offset recovery for updating the final symbol is shown at 1408 where the symbol at the index m(peak_idx+4osr) is multiplied by e^{(θ}^{ₑₛₜ}^{-2πf}^{ₑₛₜ}^{4T}^{_{sym}}⁾ and the updated symbol is stored into memory. The final symbol may be stored back into memory 1102 at m_upd(peak_idx+4osr) or into a different memory location.

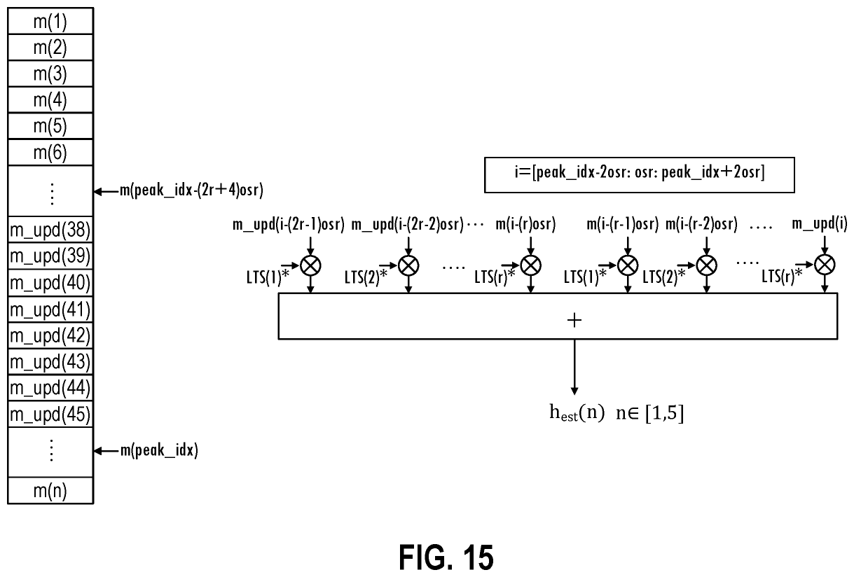

Once the stored symbols have been updated, the updated symbols are used for channel estimation. FIG. 15 illustrates an embodiment for channel estimation using correlation in which five taps are shown. In FIG. 15 hₑₛₜ(n)=m_upd(i−(2r−1)osr)×LTS(1)*+m_upd(i−(2r−2)osr)×LTS(2)*+ . . . +m_upd(i−(r)osr)×LTS(r)*+m_upd(i−(r−1)osr)×LTS(1)*+m_upd(i−(r−2)osr)×LTS(2)*+ . . . +m_upd(i)*×LTS(r)*, where n∈[1,5] and i=[peak_idx−2osr:osr:peak_idx+2×osr], where the first term (peak_idx−2osr) represents the lower bound, osr represents the increment, and (peak_idx+2osr) represents the upper bound. Thus, hₑₛₜ(n=1) is calculated based on i=peak_idx-2osr; hₑₛₜ(n=2) is calculated based on i=peak_idx−osr; hₑₛₜ(n=3) is calculated based on i=peak_idx; hₑₛₜ(n=4) is calculated based on i=peak_idx+osr; hₑₛₜn=5) is calculated based on i=peak_idx+2osr. Referring back to FIG. 5, the channel estimates (hₑₛₜ(n)) are supplied to the equalizer 507.

Thus, a demodulator providing fine timing detection and phase, frequency and channel estimation has been described. The description of the invention set forth herein is illustrative and is not intended to limit the scope of the invention as set forth in the following claims. For example, while embodiments of the invention have been described in which two long training sequence packets of identical length are used, more than two LTS packets may be used and of different lengths. In addition, the correlations described herein may include additional symbols besides LTS symbols. The terms “first,” “second,” “third,” and so forth, as used in the claims, unless otherwise clear by context, is to distinguish between different items in the claims and do not otherwise indicate or imply any order in time, location, or quality. For example, “a first received signal,” “a second received signal,” does not indicate or imply that the first received signal occurs in time before the second received signal. Variations and modifications of the embodiments disclosed herein may be made based on the description set forth herein, without departing from the scope of the invention as set forth in the following claims.

What is claimed is:

1. A method for timing detection comprising:
correlating first received symbols with a first plurality of training symbols to generate first correlation results;
correlating second received symbols with a second plurality of training symbols to generate second correlation results;
correlating third received symbols that include the first received symbols and the second received symbols with a third plurality of training symbols that include the first plurality of training symbols and the second plurality of training symbols to generate third correlation results;
identifying a plurality of peaks in the third correlation results; and
determining which of the plurality of peaks in the third correlation results is a true peak using the first correlation results and the second correlation results, the true peak corresponding to an end of a training sequence.

2. The method as recited in claim 1 wherein the first plurality of training symbols and the second plurality of training symbols are equal in number and are identical.

3. The method as recited in claim 1 wherein the third plurality of training symbols is a combination of the first plurality of training symbols and the second plurality of training symbols.

4. The method as recited in claim 1 wherein a first correlation peak in the first correlation results is indicative of receiving a first portion of a training sequence and a second correlation peak in the second correlation results is indicative of receiving a second portion of the training sequence.

5. The method as recited in claim 1 further comprising determining a first peak, a second peak, and a third peak in the third correlation results, the first peak indicative of receiving the first portion of the training sequence and the second peak corresponding to reception of the second portion of the training sequence, and the third peak corresponding to reception of a portion of a control packet after reception of the second portion of the training sequence.

6. The method as recited in claim 5 wherein the true peak is the second peak between the first peak and the third peak in the third correlation results.

7. The method as recited in claim 5 further comprising:
determining which of the first peak, the second peak, and the third peak has a highest magnitude; and
setting an initial peak index to point to a memory location corresponding to the peak with the highest magnitude.

8. The method as recited in claim 7 further comprising responsive to the initial peak index corresponding to the first peak, adjusting the initial peak index to point to a memory location corresponding to the second peak, which is the true peak.

9. The method as recited in claim 7 further comprising responsive to an initial peak index corresponding to the third peak, adjusting the initial peak index to point to a memory location corresponding to the second peak, which is the true peak.

10. The method as recited in claim 2 further comprising generating the third correlation results by summing the first correlation results and the second correlation results.

11. The method as recited in claim 7 further comprising determining a peak index corresponding to a memory location of the true peak.

12. The method as recited in claim 11 further comprising:
selecting symbols for updating to reflect a phase offset and a frequency offset using symbols selected from memory based at least in part on the peak index.

13. A receiver comprising:
a memory to store symbols received by the receiver;
a first correlator is configured to correlate first symbols from the memory and first training symbols and generate first correlation results;
a second correlator is configured to correlate second symbols from the memory and the first training symbols and generate second correlation results;
a summing circuit to generate third correlation results by summing the first correlation results and the second correlation results;
detection logic configured to identify a plurality of peaks in the third correlation results; and
wherein the detection logic determines which of the plurality of peaks in the third correlation results is a true peak using the first correlation results and the second correlation results, the true peak indicating an end of a training sequence.

14. The receiver as recited in claim 13 wherein the detection logic determines a first peak, a second peak, and a third peak in the third correlation results, the first peak indicative of receiving the first portion of the training sequence and the second peak corresponding to reception of the second portion of the training sequence, and the third peak corresponding to reception of a portion of a control packet after reception of the second portion of the training sequence.

15. The receiver as recited in claim 14 wherein the true peak is the second peak between the first peak and the third peak in the third correlation results.

16. The receiver as recited in claim 14 wherein the detection logic determines which of the first peak, the second peak, and the third peak has a highest magnitude and sets an initial peak index to point to the peak with the highest magnitude.

17. The receiver as recited in claim 16 wherein the detection logic uses existence of a first correlation peak in the first correlation results at a first memory location based on the initial peak index and existence of a second correlation peak at a second memory location based on the initial peak index to help determine which of a plurality of peaks in the third correlation results is the true peak.

18. The receiver as recited in claim 16 further comprising responsive to the initial peak index corresponding to the first peak, adjusting the initial peak index to point to a memory location corresponding to the second peak, which is the true peak.

19. The receiver as recited in claim 16 further comprising responsive to the initial peak index corresponding to the third peak, adjusting the initial peak index to point to a memory location corresponding to the second peak, which is the true peak.

20. A method for detecting timing in a receiver comprising:
generating first correlation results based at least in part on correlation of a first training sequence received by the receiver with a known first training sequence;
generating second correlation results based at least in part on correlation of a second training sequence received by the receiver with a known second training sequence;
generating third correlation results based at least in part the first training sequence combined with the second training sequence being correlated with the known first training sequence and the known second training sequence; and
determining which of a plurality of peaks in the third correlation results is a true peak based on a first peak in the first correlation results and a second peak in the second correlation results, the true peak indicative of an end of a transmission sequence.
